(19) United States
(12) Patent Application Publication
(10) Pub. No.: US 2018/0362318 A1
(43) Pub. Date: Dec. 20, 2018

(54) A BEVERAGE FONT FOR A BEVERAGE DISPENSING SYSTEM, A BEVERAGE DISPENSING SYSTEM COMPRISING A BEVERAGE FONT AND A METHOD OF DISPENSING A MIXED ALCOHOLIC BEVERAGE PRODUCT BY PROVIDING A BEVERAGE DISPENSING SYSTEM

(71) Applicant: CARLSBERG BREWERIES A/S, Copenhagen V (DK)

(72) Inventors: Jan Norager Rasmussen, Olstykke (DK); Nikolaj Heiberg Bestle, Copenhagen O (DK)

(73) Assignee: CARLSBERG BREWERIES A/S, Copenhagen V (DK)

(21) Appl. No.: 16/060,575

(22) PCT Filed: Dec. 7, 2016
(86) PCT No.: PCT/EP2016/080038

§ 371 Date: Jun. 8, 2018

(30) Foreign Application Priority Data
Dec. 8, 2015 (EP) 15198363.2

(51) Int. Cl. B67D 1/00; B67D 1/08; B67D 1/12

(52) U.S. Cl. CPC B67D 1/0028; B67D 1/0036; B67D 2001/0093; B67D 1/0888; B67D 1/1204; B67D 1/0045

(57) ABSTRACT

The present invention relates to a beverage font (10) for a beverage dispensing system. The beverage font (10) comprising a mixing conduit (24) having a first inlet (24A) for receiving a pressurized beverage defining a first alcoholic percentage and a second inlet (26) for receiving an additive defining a second alcoholic percentage. The mixing conduit (24) further having an outlet (18) for supplying a mixed alcoholic beverage product constituting a mixture of the beverage and the additive. The font (10) further comprising a control unit (38) for receiving a parameter representing a specific alcoholic percentage or a specific concentration of the additive relative to the mixed alcoholic beverage. The control unit (38) being capable of causing the additive to flow from the second inlet (26) to the mixing conduit for generating a flow of the mixed alcoholic beverage defining the specific alcoholic percentage or the specific concentration of the additive relative to the mixed alcoholic beverage through the outlet (18).

### CROSS-REFERENCE TO RELATED APPLICATIONS

This application is the national phase entry, under 35 U.S.C. Section 371(c), of International Application No. PCT/EP2016/080038, filed Dec. 7, 2016, claiming priority from European Application No. 15198363.2, filed Dec. 8, 2015. The disclosures of the International Application and the European Application from which this application claims priority are incorporated herein by reference in their entireties.

### FEDERALLY SPONSORED RESEARCH OR DEVELOPMENT

Not Applicable

### BACKGROUND

The present invention relates to a beverage font for a beverage dispensing system, a beverage dispensing system comprising a beverage font and a method of dispensing a mixed alcoholic beverage product by providing a beverage dispensing system.

Dispensing of draught beverages in commercial establishments such as bars, restaurants etc., is typically done by using a beverage dispensing system including a pressurized container and a beverage font. The beverage font includes a beverage line and a faucet. In order to dispense beverage, the operator opens the faucet and the beverage flows from the beverage container through the faucet to a glass which the operator holds or places below the faucet.

In the market, there exist two distinct types of beverage dispensing systems of which the first one is a conventional system which has been known for decades and which uses recyclable kegs and the second one being a modern system using disposable kegs. The conventional type uses a rigid metal container that is pressurized by using a carbon dioxide from a pressurized carbon dioxide bottle for pressurizing the inside of the container. The modern type uses a compressible plastic container held within a pressure chamber. The container is pressurized from the outside by air pressure from a compressor causing the container to compress during dispensing. One example of the latter type of beverage dispensing system is described in the applicant's own international application WO 07/019853 A2.

Beverages, in particular carbonated beverages such as beer and including pilsner, lager, ale, stout, porter, etc., exist in a very large number of variants. The variants are obtained by using different kinds and amounts of malts, yeasts and hops. Further, the amount of alcohol and carbon dioxide may vary significantly between different beer variants. Yet further, there exist flavored beers to which additional flavor components have been added.

It is evident that a typical establishment may only serve a limited number of variants as draught beverages as the draught beverage systems take up a lot of space in the establishment. Each draught beverage variant is provided in a large keg of typically 20-30 litres, which requires cooling, a separate faucet and separate lines, etc. Thus, each additional beverage available as draught beverage adds to the total investment for the establishment. Consequently, typical establishments provide a limited number of the most popular beverages as draught beverage, whereas beverages having less turnover may be provided in the form of bottles only.

In order to remedy the above problem, beverage dispensing systems exist in which one or more additives are injected into the stream of beverage originating from a beverage container. In this way, the availability of beverage variants is increased, since one faucet and one beverage container will be able to provide multiple beverage variants.

Soft drink machines are typically based on the above principles, since all soft drinks are based on carbonated water and an additive, which differs depending on the soft drink variant. In this way, the carbonated water is mixed with an additive in order to form a soft drink having taste of cola, orange, apple, tonic, soda, etc.

One example is described in EP 2 891 622 A1 which discloses a device for dispensing beverage allowing the injection of at least one miscible additive into a flow of a main liquid. The injection of the miscible additive is controlled by a valve. The injection may also be carried out using the venturi effect.

Another example is DE 101 26 598 B4 which describes an apparatus capable of mixing two fluids of which one may constitute a syrup and the other may constitute carbonated water.

Further, WO 2012/123462 discloses a method for portion-wise production of water-based carbonated post mixed drinks for direct consumption, wherein water is carbonated and then mixed with a pre-carbonated drink concentrate that is packaged portion-wise.

Yet further, EP 2 703 336 A1 discloses a beverage tap for mixing two components and having a flexible membrane for avoiding additive remaining in the inlet channel for the mixing channel.

U.S. Pat. No. 4,535,917 discloses a dispensing apparatus using a venturi in the supply line for causing a pressure differential.

One drawback with the above systems is the fact that it may be difficult to ensure that the concentration of the additive in relation to the beverage is consistent. In relation to soft drinks, the problem is less critical; however, in relation to alcoholic beverages it must be ensured that the final beverage has a specific alcohol content.

One aspect has to do with the fact that the government tax and thus the price of a beverage having a high alcohol percentage is significantly higher than a beverage having a low alcohol percentage.

The tax rates vary significantly between different jurisdictions. For instance, a beer having a very low abv (alcohol by volume), such as below 0.5%, may be considered “alcohol free” and without any additional taxation, whereas a beer having higher abv may have a tax rate which depends on the abv.

Further, a person wishing to use a motorized vehicle or perform other demanding tasks such as working, sporting or the like should be able to rely on receiving a beverage having a specific alcohol content in order to ensure that the person is capable of performing the task after finishing the drink. Most, if not all, countries have strict regulations in relation to driving when under the influence of alcohol, and allow no or only a small amount of alcohol prior to driving.

It is thus an object according to the present invention to provide technologies for ensuring that the concentration of the additive and thus the amount of alcohol in the mixed beverage is consistent and corresponds to the user specified values.

### SUMMARY OF THE INVENTION

At least the above object, or at least one of numerous further objects which will be evident from the below description of the present invention, is according to a first aspect of the present invention obtained by a beverage font for a beverage dispensing system, the beverage font comprising:
a mixing conduit having a first inlet for receiving a pressurized beverage defining a first alcoholic percentage, a second inlet for receiving an additive being compatible with the pressurized beverage and defining a second alcoholic percentage whereby at least one of the first alcoholic percentage and the second alcoholic percentage being greater than zero, and an outlet for supplying a mixed alcoholic beverage product constituting a mixture of the pressurized beverage and the additive, the first inlet comprising an electronically controlled main valve, the second inlet comprising an electronically controlled additive valve,
a tapping handle defining a beverage dispensing position, in which the electronically controlled main valve is open for generating a constant flow of the pressurized beverage from the first inlet via the mixing conduit to the outlet, and a non-beverage dispensing position, in which the electronically controlled main valve is closed for preventing the pressurized beverage to flow from the first inlet to the mixing conduit, and
a control unit for receiving a parameter representing a specific alcoholic percentage or a specific concentration of the additive relative to the mixed alcoholic beverage product, the control unit being capable of controlling the electronically controlled additive valve provided the tapping handle is positioned in the beverage dispensing position and based on the parameter thereby causing the additive to flow from the second inlet to the mixing conduit for generating a flow of the mixed alcoholic beverage product defining the specific alcoholic percentage or the specific concentration of the additive relative to the mixed alcoholic beverage product through the outlet.

The beverage may be pressurized by any means such as by carbon dioxide, air or even a pump directly pumping the beverage. A beverage is understood to be a water-based solution suitable for human consumption. The alcohol percentage may be zero, indicating an alcohol-free beverage; however, typically the pressurized beverage will include a non-zero percentage of alcohol. The additive should be compatible with the beverage, i.e. be miscible with the pressurized beverage and not reacting with the beverage in such a way as to form a toxic, non-edible or otherwise unsuitable product. The resulting mixed beverage product should be alcoholic, thus as least one or the additive and the pressurized beverage should be alcoholic, i.e. having a non-zero alcohol percentage. The alcoholic percentage of the mixed beverage product may typically range from 0.5% to 20%, and as such at least one of the pressurized beverage or the additive should have a non-zero alcohol percentage. For instance, the beverage may have a zero alcoholic percentage, whereas the additive has an alcoholic percentage ranging from 0.5% to 20%, or vice versa. Alternatively, both the pressurized beverage and the additive may have an alcoholic percentage of 0.5% to 20%. Knowing the alcoholic percentage and the volume of the pressurized beverage and the additive respectively, the alcoholic percentage of the mixed beverage product may be derived by simple arithmetic.

The pressurized beverage will constitute the greater part of the mixed alcoholic beverage product, which will as well be pressurized due to the pressurization of the pressurized beverage. The additive may optionally be pressurized as well. Also, the additive may include zero percent alcohol or alternatively include a non-zero percentage of alcohol. The additive is typically a liquid such as a syrup made from malt or hops, however, gasses such as N₂ or CO₂ may be used as well. Even solids, such as powders or granulates, would be feasible. The additive may include flavours such as strawberry, lime, etc.

When the tapping handle is operated, the main valve opens. The handle may be e.g. a button which is pressed or more typically in relation to beer a rod which is swung from a horizontal position to a vertical position. The pressurized beverage thus streams from the inlet into the mixing conduit and through the mixing conduit to the outlet. At the same time, the additive valve opens allowing a well-defined amount of the additive to be infused into the stream of beverage passing through the mixing conduit. The end of the mixing conduit defines a beverage outlet where the mixed alcoholic beverage product is released into a beverage glass or the like. The infusion of the additive in the mixing conduit ensures a high accuracy of the concentration of the additive in the resulting mixed alcoholic beverage product as well as a homogeneous mixture of the beverage and the additive in the mixed alcoholic beverage product. Typically, it is assumed that the main valve is either closed or fully open; however, it will be equally feasible to assume intermediate positions, in which the beverage flow is slower. The infusion of additive should thereby be adapted to keep the desired concentration.

The amount of additive to be infused into the beverage is determined by a parameter submitted by the user to the control unit. The control unit may be a microprocessor or the like capable of receiving and storing the parameter and control the additive valve based on the parameter. The parameter may define a specific concentration of the additive relative to the beverage, e.g. 20% additive and 80% beverage. Such concentration would be achieved e.g. by supplying the beverage at 2 litres/minute and the additive at 0.5 litres/min. The parameter may also define a specific percentage or alcohol in the resulting mixed alcoholic beverage product, e.g. 5%, and the control circuit may then derive the specific concentration of the additive relative to the beverage, if needed with the aid of additional parameters. For instance, the user may specify a desired taste or a desired type of beverage, preferably in combination with an alcoholic percentage, and the concentration of the additive relative to the beverage may then be determined by the control circuit to match the user's desires.

The parameter may thus be delivered directly by the user or established based on a specific taste desired by the user. A user interface, such as a knob or a wheel or any electronic equivalent, may be provided for inputting the parameter and/or taste. More elaborated user interfaces include graphical interfaces using touch screen displays illustrating the process and for inputting various user options which may comprise simple “one touch” settings which may allow the user to select one of a number of predetermined mixing relations to detailed inputting of percentages of the additive in relation to the beverage and/or alcoholic percentages.

When the user has dispensed a desired amount of beverage, the user returns the handle to the non-beverage dispensing state, thus closing both the main valve and the additive valve thereby interrupting the flow of beverage through the outlet. Since the infusion of the additive is made continuous or at least semi-continuous, the user may interrupt beverage dispensing at any time while still ensuring that the beverage and the additive are correctly mixed, i.e. that the correct concentration of the additive is preserved, thus also ensuring that the correct alcoholic percentage is maintained in the beverage at all times.

According to a further embodiment of the beverage font for a beverage dispensing system, the mixing conduit constitutes a venturi tube, the venturi tube comprising an inlet section connected to the electronically controlled main valve, an outlet section connected to the outlet and a mixing section interconnecting the inlet section and the outlet section and being further connected to the electronically controlled additive valve, the mixing section defines a smaller flow area than the inlet section and the outlet section.

The use of the venturi tube for infusing the additive into the beverage implies using the stream of beverage itself to pull the additive into the beverage stream. In this way, a very accurate inflow of additive into the beverage stream is achieved. The mixing section of the venturi, i.e. the location at which the additive and the beverage meet, defines a smaller flow area than the inlet section and the outlet section of the venturi tube and thereby the velocity of the beverage flow will be higher at the mixing section causing a suction effect known as the venturi effect resulting in that the additive will be infused with high precision into the beverage flow. There is thus no need for any active injection of the additive into the beverage flow as according to the venturi principle, the beverage itself will cause the additive to be infused.

According to a further embodiment of the beverage font for a beverage dispensing system, the control unit is capable of generating a pulse-width-modulated signal based on the parameter and controlling the additive valve by the pulse-width-modulated signal so as to continuously switch the electronically controlled additive valve between an open state and a closed state.

The pulse-width-modulated signal is based on the parameter which indicated the mixing percentage between the pressurized beverage and the additive, i.e. the concentration of the additive relative to the beverage. The pulse-width-modulated signal defines the time-period when the additive valve is open and closed, respectively, and this results in a specific percentage of additive in the mixed alcoholic beverage product. It is thereby assumed that the additive valve only has two states, one closed and one fully open. The duty cycle, i.e. the time of the total period, which the valve is open, corresponds to the desired concentration of the additive in the mixed alcoholic beverage product. E.g., assuming that the beverage flow is constant when the main valve is open, the additive flow is constant when the additive valve is open and the beverage flow is 5 times higher than the additive flow with both the main valve and the additive valve open. In such case, the concentration of the additive when keeping the additive valve open during the full time period when the handle is maintained in the beverage dispensing position is 20%, whereas an 11% concentration of the additive is achieved by a continuous opening and closing of the additive valve according to a duty cycle in which the valve is open 50% of the time and closed 50% of the time.

According to a further embodiment of the beverage font for a beverage dispensing system, the pulse-width-modulated signal defines a switching frequency of between 1 Hz and 1 kHz, preferably between 10 Hz and 100 Hz, more preferably between 30 Hz and 70 Hz, such as 50 Hz.

The switching frequency is preferably high in order to achieve a homogeneous beverage. This will improve the mixing of the additive into the beverage. Further, a high switching frequency is important since the desired concentration is only achieved over a full period. In case the user interrupts beverage dispensing during a period, the concentration will not be correct. The user may interrupt beverage dispensing at any time and in case the switching frequency is low, there is a risk that the concentration of the additive does not correspond to the desired concentration. However, the error is smaller, the higher the frequency. However, too high frequencies may be undesired due to the opening- and closing times of the valve, which typically is in the order of magnitude of 1 millisecond. Thus, the above-indicated switching frequencies define a good trade-off between the above-described cause of errors.

According to a further embodiment of the beverage font for a beverage dispensing system, the additive valve is a proportional valve capable of assuming a partially open state based on the parameter.

Alternatively, instead of controlling the valve using a pulse-width modulated signal, the valve may be a proportional valve which will assume a fixed and partially open state over the whole duration of the beverage dispensing. The percentage of the valve aperture and thus the flow area which will be open relates to the desired concentration, i.e. the larger the opening, the higher the concentration of the additive in the mixed alcoholic beverage product. Thus, according to the desired concentration of the additive, the fixed opening percentage will be defined by the control unit to a value between and including completely closed to fully open.

According to a further embodiment of the beverage font for a beverage dispensing system, the mixing conduit comprises a number of further inlets adjacent the second inlet for receiving a respective further additive, each being compatible with the pressurized beverage and defining a further alcoholic percentage, each of the further inlets comprising a respective further electronically controlled additive valve, the number for example being between 1 and 50, preferably between 2 and 20, more preferably between 3 and 10, most preferably between 4 and 8, such as between 5 and 7, or 6.

In order to achieve further variations in the selection of the beverage, there is preferably more than one additive. The additional additives may be infused into the beverage in the same way as described above in relation to the first additive. The control circuit should take all additives into account when calculating the concentrations of each additive in the mixed alcoholic beverage product, and alcoholic percentage of the mixed alcoholic beverage product and the additive valves should be controlled accordingly. The above number of additives is suitable for achieving a large number of beverage variants.

In case the control unit controlling the further electronically controlled additive valves is using the pulse-width-modulated signal for opening and closing the further electronically controlled additive valves according to the pulse width modulated signal, it may be preferred to configure the further electronically controlled additive valves such that only a single electronically controlled additive valve is open at each time.

According to a further embodiment of the beverage font for a beverage dispensing system, the mixing conduit comprises a third inlet having an electronically controlled auxiliary valve for receiving a pressurized auxiliary beverage defining an auxiliary alcoholic percentage, and, provided the tapping handle is positioned in the beverage dispensing position, the electronically controlled main valve and the electronically controlled auxiliary valve are controlled by the control unit according to an auxiliary parameter.

Further, the incoming beverage may constitute a mixture of two beverages, or there may be a choice between two main beverages, e.g. a lager and an ale, or an alcoholic beverage and a non-alcoholic beverage. The electronically controlled main valve and the electronically controlled auxiliary valve are controlled by the handle and by the control circuit such that the opening and closing itself is controlled by the handle, whereas the control circuit determines based on the user's input which of the electronically controlled main valve and the electronically controlled auxiliary valve should be open. The electronically controlled main valve and the electronically controlled auxiliary valve may also be proportional valves or pulse-width-controlled valves as described above in connection with the additive valve in order to achieve an accurate mixture between the two pressurized beverages, i.e. the beverage and the auxiliary beverage.

According to a further embodiment of the beverage font for a beverage dispensing system, the beverage dispensing system further includes a fixed or movable electronic computer device communicating wirelessly or by wire with the control unit for generating the parameter, the computer device preferably including a graphical user interface.

The electronic computer device may for instance be a laptop, a tablet or a similar device integrated into the font or the system. The electronic computer device provides a user interface between the control unit and the user. The electronic computer device may include a keyboard or touchscreen for inputting information The user may either input the parameter directly and thus defining the relationship between the additive(s) and the beverage(s), or the user may input some other information such as alcohol content, type and/or flavors. The information is used for generating the parameter(s) which is sent to the control unit. Different modes may be provided, such as expert mode allowing the user to access all of the possible settings for allowing the user to make a personalized mixed beverage, and simple mode in which the user may select from a number of pre-selectable mixed beverages. The electronic computer device may also include a screen for providing additional information assisting the user in the choice of beverage before dispensing, showing details such as volume, alcohol content and so on during and after dispensing.

According to a further embodiment of the beverage font for a beverage dispensing system, the mixed alcoholic beverage product is composed of no more than 30% of the additive or the additives, preferably no more than 20%, more preferably no more than 10%, most preferably no more than 5%.

Typically, the major part of the mixed beverage product is composed of pressurized beverage and a minor part is additive. The additives may preferably be provided in a concentrated form so that a small volume of the additive will yield a large change in the taste of the beverage. In this way, the additive containers may be made small and thus take up less space in the vicinity of the font.

At least the above object, or at least one of numerous further objects which will be evident from the below description of the present invention, is according to a second aspect of the present invention obtained by a beverage dispensing system comprising a beverage font according to any of the preceding claims, a beverage container connected to the first inlet and an additive container connected to the second inlet.

Typically, the above-described font is built into a beverage dispensing system, which further comprises the pressurized beverage container and the additive container. Multiple additive containers and multiple beverage containers are feasible as described above.

According to a further embodiment of the system, the beverage container is located inside a pressure chamber, or alternatively the beverage container is connected to an external pressure source.

The beverage dispensing system may either be of the conventional type, in which the beverage is stored in a metal keg which is pressurized by carbon dioxide or another suitable mixed gas from a gas bottle, or the modern type in which the beverage is stored in a collapsible keg made of plastic and positioned within a pressure chamber which is pressurized by means of a pressure source such as an air compressor.

According to a further embodiment of the system, the pressurized beverage is a carbonated beverage, preferably beer.

The present system is particularly useful for carbonated alcoholic beverage which is to be stored under pressure for keeping fresh and fizzy. Preferably, the present system is used for beer, which is known to exist in a multitude of variants.

According to a further embodiment of the system, the additive is a fluid, preferably an aqueous solution or a gas, more preferably a gas including CO₂ or N₂, and/or, an aqueous solution including alcohol or sugar, such as a syrup or a liquor.

Whereas the pressurized beverage will be a liquid, the additive may be any fluid that is compatible with the liquid. Preferably, a syrup is used such as a barley syrup or a hops syrup. Alcoholic liquors may also be used to increase the alcoholic percentage of the mixed beverage product.

At least the above object, or at least one of numerous further objects, which will be evident from the below description of the present invention, is according to a third aspect of the present invention obtained by a method of dispensing a mixed alcoholic beverage product by providing a beverage dispensing system, the beverage dispensing system comprising a beverage font, a beverage container including a pressurized beverage defining a first alcoholic percentage and an additive container including an additive being compatible with the pressurized beverage and defining a second alcoholic percentage, whereby at least one of the first alcoholic percentage and the second alcoholic percentage being greater than zero, the beverage font comprising:
a mixing conduit having a first inlet connected to the beverage container, a second inlet connected to the additive container, and an outlet, the first inlet comprising an electronically controlled main valve, the second inlet comprising an electronically controlled additive valve,
a tapping handle defining a beverage dispensing position and a non-beverage dispensing position, and
a control unit,
the method further comprising the following steps:
receiving by the control unit a parameter representing a specific alcoholic percentage or a specific concentration of the additive relative to the mixed alcoholic beverage product,
changing the tapping handle from the non-beverage dispensing position, in which the electronically controlled main valve is closed for preventing the pressurized beverage to flow from the first inlet to the mixing conduit, to the beverage dispensing position, in which the electronically controlled main valve is open for generating a constant flow of the pressurized beverage from the first inlet via the mixing conduit to the outlet, and
controlling the electronically controlled additive valve by using the control unit, thereby causing the additive to flow from the second inlet to the mixing conduit for generating a flow of the mixed alcoholic beverage product defining the specific alcoholic percentage or the specific concentration of the additive relative to the mixed alcoholic beverage product through the outlet.

The method according to the third aspect is preferably used with the font according to the first aspect and the system according to the second aspect.

At least the above object, or at least one of numerous further objects, which will be evident from the below description of the present invention, is according to a fourth aspect of the present invention obtained by a beverage dispensing system comprising a beverage font comprising an outlet for supplying a mixed alcoholic beverage product constituting a mixture of a pressurized beverage and an additive, and further in close proximity to the beverage font:
a mixing conduit having a first inlet for receiving the pressurized beverage defining a first alcoholic percentage and a second inlet for receiving the additive being compatible with the pressurized beverage and defining a second alcoholic percentage, whereby at least one of the first alcoholic percentage and the second alcoholic percentage being greater than zero, the first inlet comprising an electronically controlled main valve, the second inlet comprising an electronically controlled additive valve,
a beverage container connected to the first inlet,
an additive container connected to the second inlet,
a tapping handle defining a beverage dispensing position, in which the electronically controlled main valve is open for generating a constant flow of the pressurized beverage from the first inlet via the mixing conduit to the outlet, and a non-beverage dispensing position, in which the electronically controlled main valve is closed for preventing the pressurized beverage to flow from the first inlet to the mixing conduit,
a control unit for receiving a parameter representing a specific alcoholic percentage or a specific concentration of the additive relative to the mixed alcoholic beverage product, the control unit being capable of controlling the electronically controlled additive valve provided the tapping handle is positioned in the beverage dispensing position and based on the parameter, thereby causing the additive to flow from the second inlet to the mixing conduit for generating a flow of the mixed alcoholic beverage product defining the specific alcoholic percentage or the specific concentration of the additive relative to the mixed alcoholic beverage product through the outlet.

In some cases, it may be preferred to have the mixing conduit outside and in close proximity to the font. This may save some space at the font; however, the drawback is that there will be some mixed beverage product remaining in the font which may influence the taste of the next beverage to be dispensed.

### BRIEF DESCRIPTION OF THE DRAWINGS

FIG. 1 is a perspective view of a beverage font according to the present invention.

FIG. 2A is a front view of a beverage font according to the present invention.

FIG. 2B is a side view of a beverage font according to the present invention.

FIG. 3 is a cutout view of a beverage font according to the present invention.

FIG. 4 is a close-up view of a beverage font according to the present invention.

FIG. 5A is a front view of a tapping head according to the present invention.

FIG. 5B is a perspective view of a tapping head according to the present invention.

FIG. 6A is a side view of a tapping head according to the present invention.

FIG. 6B is a cutout view of a tapping head according to the present invention.

FIG. 7 is a view of a beverage dispensing system according to the present invention.

### DETAILED DESCRIPTION

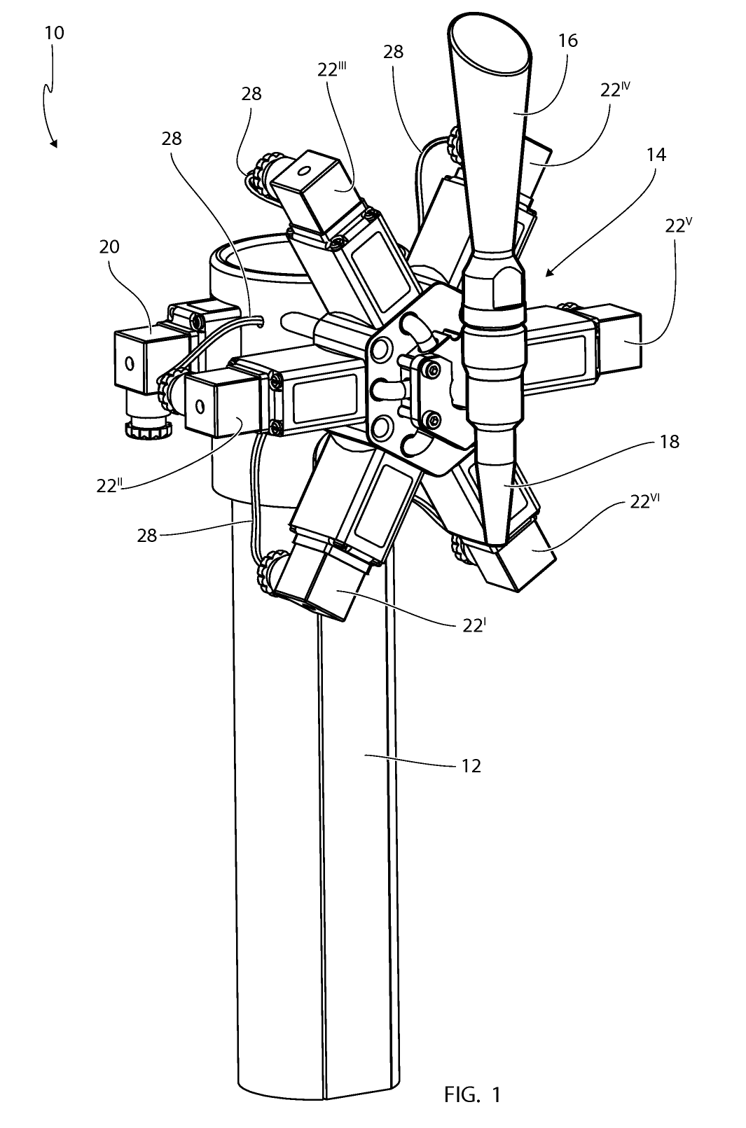

FIG. 1 shows a perspective view of a beverage font 10 according to the present invention. The font 10 is forming part of a beverage dispensing system (not shown). The font 10 comprises a hollow stanchion 12, which is connected on one end to a tapping head 14 and on the other end to a bar counter or the like (not shown). The tapping head comprises a tapping handle 15, which is shown in its closed upright position which, however, may be swung into a horizontal position for initiating beverage dispensing through a beverage outlet 18. The handle 16 is connected to a main beverage valve 20, which controls the flow of beverage between a pressurized container (not shown) and the outlet 18. The main beverage valve 20 is electronically controlled. In addition, the tapping head 14 according to the present embodiment comprises six electronically controlled additive valves 22^{I-VI}, however, the number of additive valves 22^{I-VI} may range from a single one, which is considered the basic variant, to any feasible number above six, provided sufficient space is available. The additive valves 22^{I-VI} control the infusion of additives into the pressurized beverage before the beverage flows out of the outlet 18. A control unit (not shown) controls the additive valves 22^{I-VI} based on a parameter provided by the user.

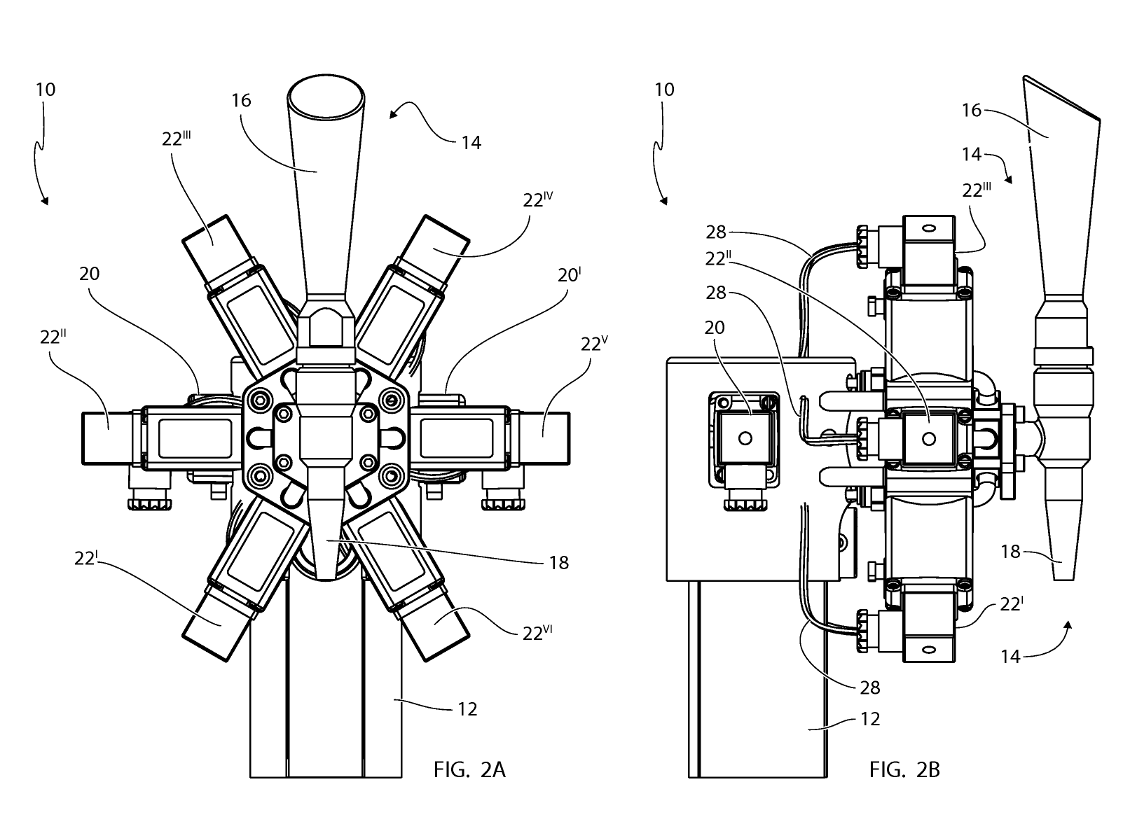

FIG. 2A shows a front view of a beverage font 10 according to the present invention. In this view, an auxiliary beverage valve 20′, which is used for providing an alternative pressurized beverage in addition to the pressurized beverage through the main beverage valve. When the handle 16 is swung into the horizontal position for initiating beverage dispensing through the outlet 18, the opening of the main beverage valve and/or the auxiliary beverage valve 20′ is based on a user parameter provided to the control unit (not shown). Thus, either one or both of the valves 20 20′ opens when the handle 16 is swung into the horizontal position, depending on the user parameter.

FIG. 2B shows a side view of a beverage font 10 according to the present invention. It can be seen that the beverage valves 20 20′ and the additive valves 22^{I-VI} are located in close proximity to the beverage outlet in order to avoid a large amount of mixed beverage remaining in the font 10, as such beverage apart from contributing a hygienically problem may also influence the taste of the next dispensing, which may be a beverage having another flavor.

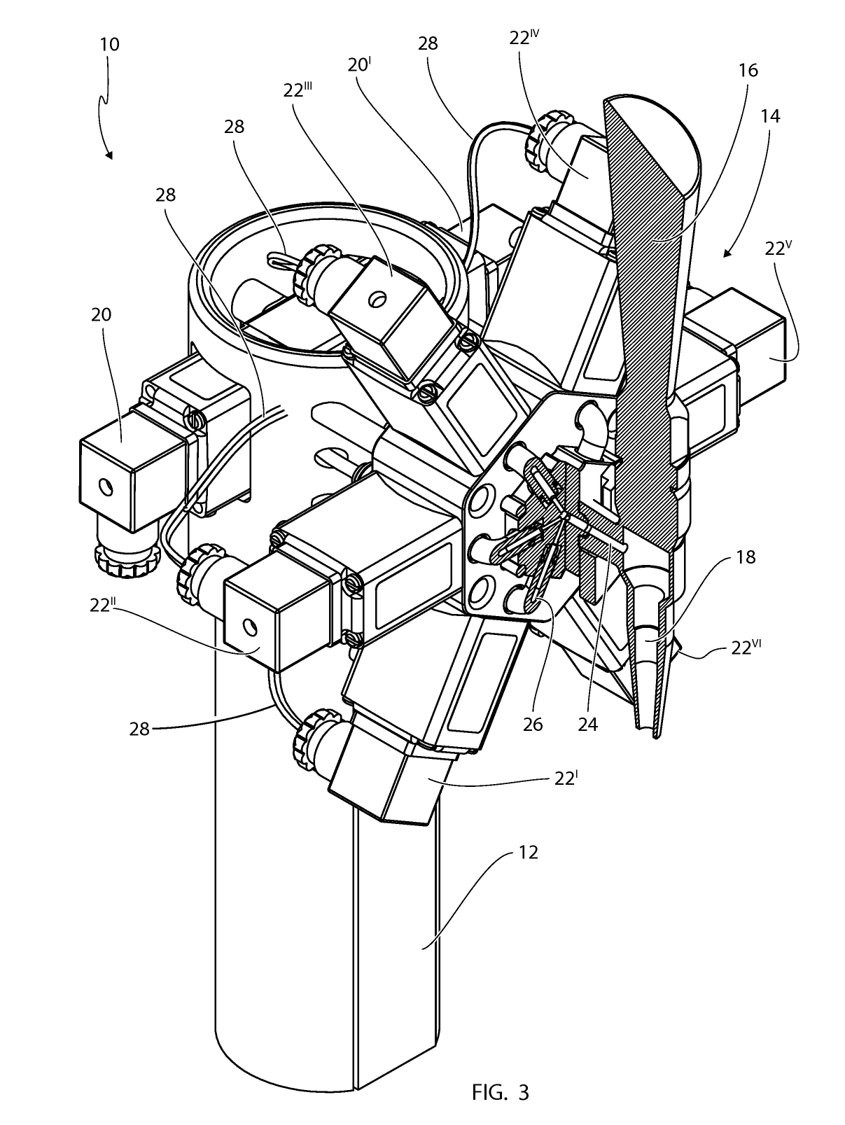

FIG. 3 shows a cutout view of a beverage font 10 according to the present invention. The pressurized beverage is led from the main beverage valve 20 and/or the auxiliary beverage valve 20′ via a mixing conduit 24 to the outlet 18. The mixing conduit 24 constitutes a venturi tube having a small flow area causing the beverage to flow at an increased velocity. The mixing conduit is connected to a number of additive conduits 26 at right angle to the flow of the pressurized beverage. The number of additive conduits corresponds to the number of additive valves 22.

As the handle 16 is swung into the horizontal position for initiating beverage dispensing through the outlet 18, the pressurized beverage will flow through the main beverage valve 20 and/or the auxiliary beverage valve 20′ depending on the user parameter, via the mixing conduit 24 to the outlet 18. As the mixing conduit 24 and the additive conduits 26 act as a venturi tube, additive will be infused into the mixing conduit 24 via the respective additive conduits 26, provided the respective additive valve 22 is open. Whether a specific additive valve is open or not depends on the user parameter, i.e. whether or not the user desires the additive or not. Thus, only one or some of the additive valves 22 may be open depending on the parameter provided by the user.

The additive valves 22 may be partially open for infusing a reduced amount of additive compared to a fully open valve. This allows a very accurate infusion of a specific amount or concentration of the additive, either by means of a switch-mode-controlled valve, which is rapidly switching between fully open or closed, or a proportional valve, which assumes a reduced aperture, compared to the fully open aperture. The control unit (not shown), which monitors the concentration of the additive, controls the additive valves 22 and the alcohol percentage in the mixed beverage product, which is, dispensed though the outlet 18.

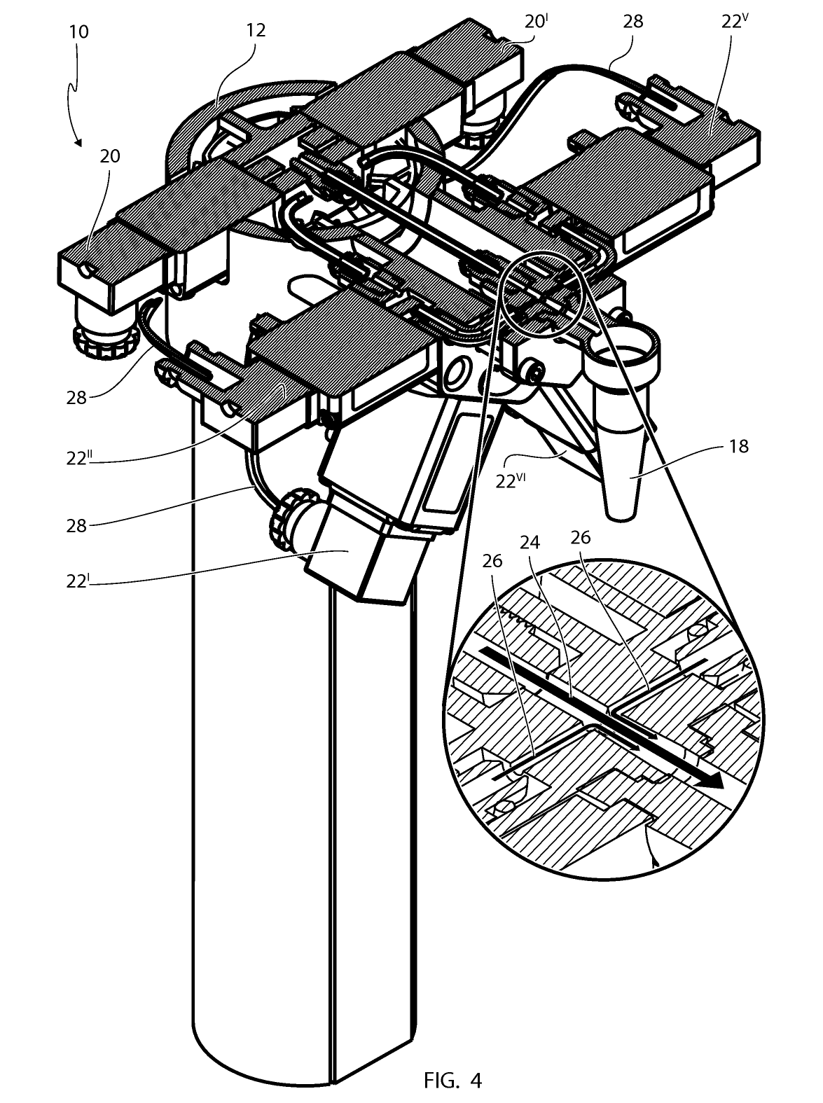

FIG. 4 is a close-up view of a beverage font 10 according to the present invention. In the present view, the main beverage valve 20, the auxiliary beverage valve 20′ and two of the additive valves 22 are shown together with the corresponding mixing conduit 24 and the additive conduits 26 entering the hollow stanchion 12. The beverages and the additives are provided from containers located in the vincinity of or below the bar counter (now shown). The valves 20 22 are controlled by the control unit (not shown) by wires 28 which are led through the hollow stanchion 12.

The flows of the beverage and of the additives are shown by the arrows. At the outlet 18, the additives and the beverage are mixed to form a homogeneous mixed beverage product having a pre-determined alcoholic content.

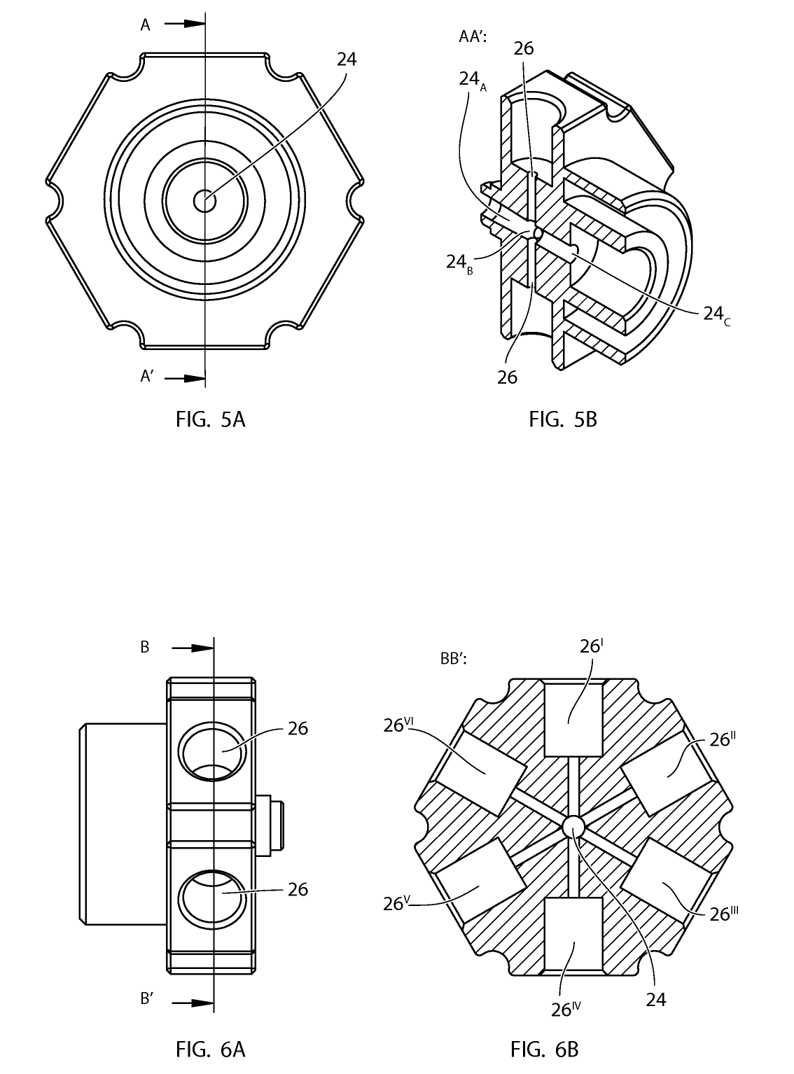

FIG. 5A shows a front view of a tapping head 14 according to the present invention. The central part of the tapping head 14 defines a circular shape and a central mixing conduit 24.

FIG. 5B shows a perspective view of a tapping head 14 according to the present invention. The mixing section 24B of the mixing conduit 24 defines a smaller flow area than the inlet section 24A and the outlet section 24c of the mixing conduit 24 for establishing a high velocity through the mixing section 24A to enhance the Venturi effect for infusing the additives via the additive conduits 26.

FIG. 6A shows a side view of a tapping head 14 according to the present invention. The additive conduits 26 enter the tapping head 14 and fluidly connect to the mixing conduit 24 from a radial direction.

FIG. 6B shows a cut-out view of a tapping head 14 according to the present invention. Each of the six additive conduits 26 connects to the mixing conduit by a 60 degree angle relative to the neighboring additive conduits 26.

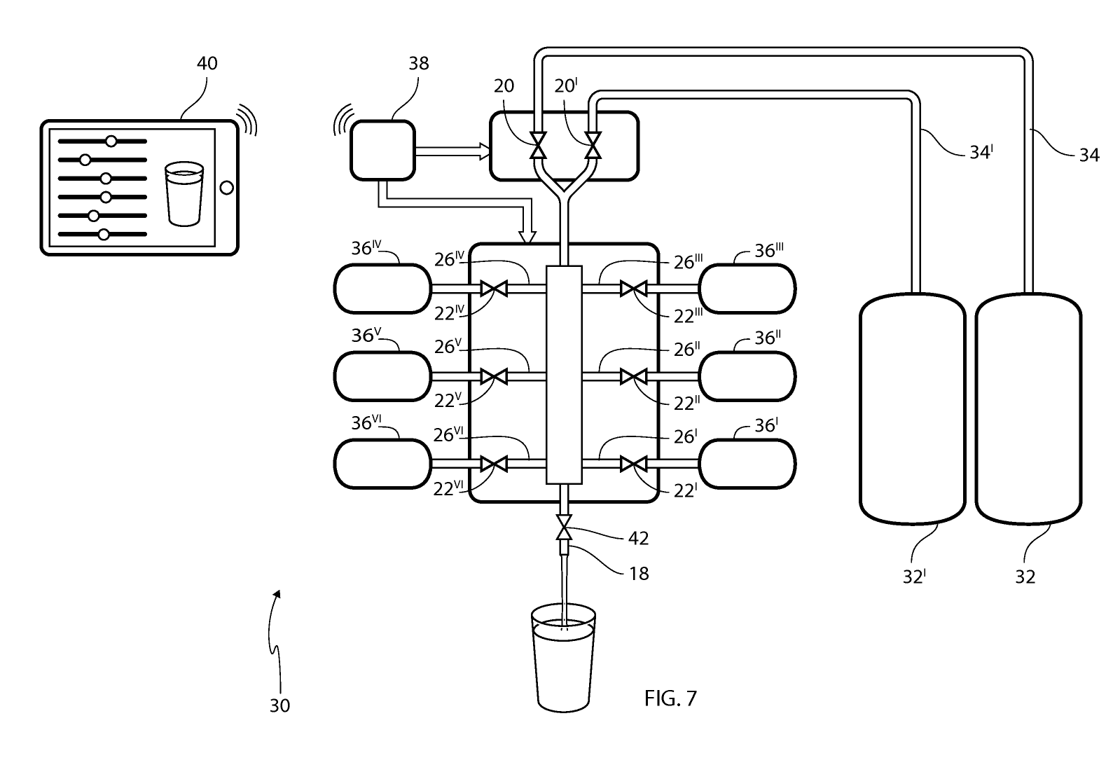

FIG. 7 is a view of a beverage dispensing system 30 according to the present invention. The beverage dispensing systems 30 comprises two pressurized beverage containers 32 32′ including a respective beverage, preferably a carbonated beverage such as beer. The beverage containers 32 32′ are connected to a respective electronic beverage valve 20 20′ via a respective beverage conduit 34 34′. The beverage valves 20 20′ are connected to a common mixing conduit 24. The mixing conduit 24 leads to a beverage outlet 18 via an optional dispensing valve 42, which is controlled by the handle 16.

The mixing conduit is between the beverage valves 20 and the outlet 18 further connected to a set of additive conduits forming a substantially right angle in relation to the mixing conduit 24. Each of the additive conduits 26 are connected to a respective additive container 36 including a respective additive via a respective additive valve 22. The beverage valves 20 and the additive valves 22 are controlled by a control unit 38.

The control unit 38 is controlled via an electronic computer device 40, which may be a laptop, or a tablet or a similar device integrated in the system 30, which functions as a user interface for the user operating the beverage dispensing system 30. The electronic computer device 40 may include a graphical user interface allowing the user to set the parameters defining a user specified mixed beverage product which is defined as a mixture between one or more beverages and additives at specific user defined concentrations. The user may also be informed about and amend the alcohol content of the beverage. As the user swings the handle 16 into a horizontal position for initiating beverage dispensing through a beverage outlet 18, the beverage valves and the additive valves are opened and/or closed by the control unit according to the parameters specified by the user.

It is evident that the above-described embodiments merely describe possible realizations according to the present invention and that further modifications and specifications such as choice of specific materials and dimensions will as such be apparent to the skillful individual.

### REFERENCE NUMERALS WITH REFERENCE TO THE DRAWINGS

10. Beverage font
12. Stanchion
14. Tapping head
16. Tapping handle
18. Beverage outlet
20. Main valve
22. Additive valve
24. Mixing conduit
26. Additive conduit
28. Electrical wiring
30. Beverage dispensing system
32. Beverage container
34. Beverage conduit
36. Additive container
38. Control unit
40. Electronic computer device
42. Optional dispensing valve
(′) and roman letters denote variants
(a), (b) and (c) denote sub-parts

1-15. (canceled)

16. A beverage font for a beverage dispensing system, said beverage font comprising:
a mixing conduit including (a) a first inlet configured for receiving a pressurized beverage having a first alcoholic percentage, (b) a second inlet configured for receiving an additive compatible with said pressurized beverage and having a second alcoholic percentage, and (c) an outlet configured for supplying a mixed alcoholic beverage product comprising a mixture of said pressurized beverage and said additive, said first inlet comprising an electronically controlled main valve, said second inlet comprising an electronically controlled additive valve;
a tapping handle having a dispensing position in which said electronically controlled main valve is open for generating a constant flow of said pressurized beverage from said first inlet via said mixing conduit to said outlet, and a non-dispensing position, in which said electronically controlled main valve is closed for preventing said pressurized beverage from flowing from said first inlet to said mixing conduit; and
a control unit configured for receiving input defining a selected value of a mixture parameter, said control unit being operable to control said electronically controlled additive valve when said tapping handle is in said dispensing position and based on said selected value of said mixture parameter, thereby causing said additive to flow from said second inlet to said mixing conduit for generating a flow of said mixed alcoholic beverage product having said selected value of said mixture parameter through said outlet.

17. The electronic beverage font according to claim 16, wherein said mixture parameter represents one of a specific alcoholic percentage and a specific concentration of said additive relative to said mixed alcoholic beverage product.

18. The electronic beverage font according to claim 16, wherein said mixing conduit includes a venturi tube comprising an inlet section defining a first flow area connected to said electronically controlled main valve, an outlet section defining a second flow area connected to said outlet, and a mixing section interconnecting said inlet section and said outlet section and to said electronically controlled additive valve, said mixing section defining a third flow area smaller than said first flow area and said second flow area.

19. The electronic beverage font according to claim 16, wherein said control unit is configured for (a) generating a pulse-width-modulated signal based on said selected value of said mixture parameter, and (b) controlling said electronically-controlled additive valve by said pulse-width-modulated signal so as to continuously switch said electronically controlled additive valve between an open state and a closed state.

20. The electronic beverage font according to claim 19, wherein said mixing conduit comprises at least one further inlet adjacent said second inlet for receiving a respective further additive that is compatible with said pressurized beverage and having a further alcoholic percentage, each of said further inlets comprising a respective further electronically controlled additive valve.

21. The electronic beverage font according to claim 20, wherein said control unit is configured for controlling each of said further electronically controlled additive valves using said pulse-width-modulated signal for opening and closing each of said further electronically controlled additive valves according to said pulse-width-modulated signal, such that only a single electronically controlled additive valve is open at each time.

22. The electronic beverage font of claim 21, wherein said pulse-width-modulated signal has a switching frequency of between 1 Hz and 1 kHz.

23. The electronic beverage font according to claim 16, wherein said additive valve is a proportional valve operable to assume a partially open state based on said selected value of said mixture parameter.

24. The electronic beverage font according to claim 16, wherein said mixing conduit comprises a third inlet having an electronically controlled auxiliary valve and configured for receiving a pressurized auxiliary beverage having an auxiliary alcoholic percentage, and wherein, when said tapping handle is in said beverage dispensing position, said electronically controlled main valve and said electronically controlled auxiliary valve are controlled by said control unit according to a selected value of an auxiliary mixture parameter.

25. The electronic beverage font according to claim 16, wherein said control unit is configured to receive said mixture parameter from an electronic computer device.

26. The electronic beverage font according to claim 16, wherein said mixed alcoholic beverage product comprises no more than 30% of said additive.

27. The electronic beverage font according to claim 16, wherein said first inlet is configured for fluid connection to a beverage container, and wherein said second inlet is configured for fluid connection to an additive container.

28. The electronic beverage font according to claim 27, wherein said beverage container is pressurized.

29. The electronic beverage font according to claim 16, wherein said pressurized beverage is a carbonated beverage.

30. The electronic beverage font according to claim 16, wherein said additive is a fluid selected from the group consisting of at least one of an aqueous solution, a gas including one of CO₂ or N₂, and an aqueous solution including one of alcohol and sugar.

31. The electronic beverage font according to claim 16, wherein one of said first alcoholic percentage and said second alcoholic percentage is zero.

32. A method of dispensing a mixed alcoholic beverage product, comprising:
providing a beverage dispensing system, comprising a beverage font, a beverage container containing a pressurized beverage having a first alcoholic percentage, and an additive container containing an additive compatible with said pressurized beverage and having a second alcoholic percentage, said beverage font comprising:
a mixing conduit having a first inlet connected to said beverage container, a second inlet connected to said additive container, and an outlet, said first inlet comprising an electronically controlled main valve, said second inlet comprising an electronically controlled additive valve;
a tapping handle having a dispensing position in which said electronically controlled main valve is open to allow a constant flow of said pressurized beverage from said first inlet via said mixing conduit to said outlet, and non-dispensing position in which said electronically controlled main valve is closed to prevent said pressurized beverage from flowing from said first inlet to said mixing conduit; and
a control unit;
the method further comprising:
receiving by said control unit a selected value of a mixture parameter;
changing said tapping handle from said non-dispensing position to said dispensing position; and
controlling said electronically controlled additive valve using said control unit, thereby causing said additive to flow from said second inlet to said mixing conduit for generating a flow of said mixed alcoholic beverage product having said selected value of said mixture parameter through said outlet.

33. The method of claim 32, wherein said mixture parameter represents one of a specific alcoholic percentage and a specific concentration of said additive relative to said mixed alcoholic beverage product.

34. A beverage dispensing system comprising:
a beverage font comprising an outlet configured for supplying a mixed alcoholic beverage product comprising a mixture of a pressurized beverage having a first alcoholic percentage, and an additive compatible with said pressurized beverage and having a second alcoholic percentage;
a mixing conduit having a first inlet configured for receiving said pressurized beverage having a first alcoholic percentage and a second inlet configured for receiving said additive being compatible with said pressurized beverage and defining a second alcoholic percentage, said first inlet comprising an electronically controlled main valve, said second inlet comprising an electronically controlled additive valve;
a beverage container connected to said first inlet;
an additive container connected to said second inlet;
a tapping handle having a dispensing position in which said electronically controlled main valve is open for generating a constant flow of said pressurized beverage from said first inlet via said mixing conduit to said outlet, and a non-dispensing position, in which said electronically controlled main valve is closed for preventing said pressurized beverage from flowing from said first inlet to said mixing conduit;
a control unit configured for receiving a selected value of a mixture parameter, said control unit being operable for controlling said electronically controlled additive valve when said tapping handle is in said dispensing position and based on said selected value of said mixture parameter, thereby causing said additive to flow from said second inlet to said mixing conduit for generating a flow of said mixed alcoholic beverage product having said selected value of said mixture parameter through said outlet.

35. The beverage dispensing system according to claim 34, wherein said mixture parameter represents one of a specific alcoholic percentage and a specific concentration of said additive relative to said mixed alcoholic beverage product.
